(19) United States
(12) Patent Application Publication
(10) Pub. No.: US 2010/0040201 A1
(43) Pub. Date: Feb. 18, 2010

(54) Cathode with a Coating Near the Filament and Methods for Making Same

(75) Inventor: David S.K. Lee, Salt Lake City, UT (US)

Correspondence Address: WORKMAN NYDEGGER/Varian;1000 Eagle Gate Tower, 60 East South Temple, Salt Lake City, UT, 84111, US

(73) Assignee: VARIAN MEDICAL SYSTEMS, INC., Palo Alto, CA (US)

(21) Appl. No.: 12/192,001

(22) Filed: Aug. 14, 2008

(51) Int. Cl. H01J 35/06; H01J 9/00

(52) U.S. Cl. 378/136; 445/28

(57) ABSTRACT

One or more components of an x-ray cathode assembly are manufactured using a metal deposition process. The deposition process is carried out by providing a cathode shield and a cathode head with a cathode cup and a filament slot fabricated from a first metal, and forming a coating comprising a second metal on at least a portion of at least one of the filament slot, cathode cup, cathode head, and/or cathode shield using a deposition process so as to yield the x-ray cathode assembly. The deposition process is continued until a desired thickness of metal is achieved. Example deposition processes include electroforming, chemical vapor deposition, physical vapor deposition, plasma spray, high velocity oxygen fuel thermal spray, and detonation thermal spraying.

### BACKGROUND OF THE INVENTION

1. Field of the Invention

Embodiments of the present invention relate generally to x-ray systems, devices, and related components. More particularly, embodiments of the invention relate to x-ray cathode assemblies that are manufactured using a deposition process.

2. Related Technology

The x-ray tube has become essential in medical diagnostic imaging, medical therapy, and various medical testing and material analysis industries. An x-ray tube typically includes a cathode assembly and an anode assembly disposed within an enclosure that is under a very high vacuum. The cathode assembly generally consists of a metallic cathode head assembly and a filament that acts as a source of electrons for generating x-rays. The anode assembly, which is generally manufactured from a refractory metal such as tungsten, includes a target surface that is oriented to receive electrons emitted by the cathode assembly.

During operation of the x-ray tube, the cathode is charged with a heating current that causes electrons to “boil” off the filament by the process of thermionic emission. An electric potential on the order of about 40 kV to over about 200 kV is applied between the cathode and the anode in order to accelerate electrons boiled off the filament toward the target surface of the anode assembly. X-rays are generated when the highly accelerated electrons strike the target.

Most of the electrons that strike the anode dissipate their energy in the form of heat. Some electrons, however, interact with the atoms that make up the target and generate x-rays. The wavelength of the x-rays produced depends in large part on the type of material used to form the anode surface. X-rays are generally produced on the anode surface through two separate phenomena. In the first, the electrons that strike the anode carry sufficient energy to “excite” or eject electrons from the inner orbitals of the atoms that make up the target. When these excited electrons return to their ground state, they give up the excitation energy in the form of x-rays with a characteristic wavelength. In the second process, some of the electrons from the cathode interact with the atoms of the target element such that the electrons are decelerated around them. These decelerating interactions are converted into x-rays by conservation of momentum through a process called bremsstrahlung. Some of the x-rays that are produced by these processes ultimately exit the x-ray tube through a window of the x-ray tube, and interact with a material sample, patient, or other object.

A typical cathode assembly includes at least one filament, a cathode head, a cathode shield, a cathode cup, and a cathode head/shield support. The filament or filaments are disposed within at least one slot defined within the cathode cup. In high performance x-ray tubes, cathode head and shield assemblies are typically composed of a high purity nickel, such as Ni 270 (the purest commercial grade) or Ni 205, high purity molybdenum, high purity iron, or high purity stainless steel. The filament typically comprises a wire made of tungsten or similar material that is uniformly wound about a mandrel to form a helix. The ends of the filament wire are electrically connected to metal leads disposed in the bottom of the cathode cup slot.

The Ni 270 or Mo cathode head or shield is typically fabricated from a metal bar or plate that is made by a powder metallurgy process by pressing powdered metal into a mold and fusing the metal powder under high heat and pressure. The metal is subsequently extruded, rolled, and/or forged to form a cathode head or shield. Because the surface of a typical cathode must be as smooth and clean as possible, the cathode head and shield are made by mechanical machining and/or electrical discharge machining, and are generally finished by electropolishing or chemical etching. Final assembly steps include brazing or welding ceramic eyelets onto the cathode head and adding filaments to the cathode assembly.

When a cathode fails, the failure is often due to filament arcing and filament short circuiting to the cathode head. Arcing can occur when the cathode has a grid voltage, typically 3 kV. It contributes to failure of the cathode when a strong arc between the filament and the cathode body causes melting and/or vaporization of the metal at the site of the arc. Metals used to manufacture typical cathode bodies (e.g., Ni or Mo) can be melted or vaporized by strong arcing. Localized melting and/or vaporization of the cathode surface can lead to chronic arcing and cathode failure.

Filament short circuiting often occurs through normal operation of the cathode. For example, there is typically very little distance between the filament and the cathode body in the cathode assembly. When the filament is heated to a high temperature typically needed for x-ray production, it expands and can sag or bend and touch the cathode body leading to a short circuit between the filament and the cathode head. The filament can also touch the head as a result of a physical shock or vibration during operation. In a typical cathode assembly, this contact between the filament and the cathode body leads to certain failure of the cathode because the heat generated at the site of the short circuit is great enough to melt the surface of the body and to weld the filament to the body. The filament often remains fused to the cathode head even after the x-ray tube power is turned off and the x-ray tube cools down.

### SUMMARY

Embodiments of he present invention are directed to x-ray cathode assemblies that are coated with a layer of material and methods for manufacture thereof The coating process can be used to coat essentially all portions of a cathode assembly or a portion of the cathode assembly. In disclosed embodiments, the coating process can be used to provide a durable, high melting, and 100% dense coating to the outer and inner surfaces of an x-ray cathode assembly. In addition, the coating process can be used to apply metals and other material to the outer surface of the x-ray cathode assembly that cannot be readily applied using traditional metal coating techniques. The coating process can be used to manufacture x-ray cathode assemblies with a unique design and/or improved material properties.

By way of example, the deposition process used to apply the coating to the x-ray cathode assembly can be carried out by providing a cathode shield and a cathode head with a cathode cup and a filament slot formed in the head. In one embodiment, the cathode shield and the cathode head are fabricated from a first metal (e.g., molybdenum, nickel, stainless steel, and combinations thereof) and bonded together to form a unitary structure. The cathode head and shield have a top surface, a bottom surface, and at least one side surface. In the example cathode assembly, the cathode cup and filament slot are formed as a series of stepped depressions protruding into the top surface of the cathode head. The metal deposition is carried out by forming a coating comprising a second metal on at least a portion of at least one of the cathode head, filament slot, cathode cup, and/or cathode shield using a deposition process so as to yield the x-ray cathode assembly.

Suitable deposition processes of the present invention include, but are not limited to, electrodeposition or electroforming, chemical vapor deposition (CVD), physical vapor deposition (PVD), vacuum plasma spray, high velocity oxygen fuel thermal spray, and detonation thermal spraying. These processes can be used to deposit high melting point metals typically used in manufacturing high performance x-ray cathode assemblies. Examples of high melting point metals that can be used to coat components of an x-ray cathode assembly include, but are not limited to Mo, Ta, Re, W, Nb, V, Ir, Rh, Pt, and Pd. In some instances, it may be advantageous to convert at least a portion of the metal coating to a carbide, a nitride, or an oxide, where appropriate.

A metal deposition process used to manufacture an x-ray cathode assembly can preferably be carried out using electodeposition. Electrodeposition is a process wherein a high melting point metal is transferred from a metal anode composed of the high melting point metal to a cathode composed of another metal. In this case, the cathode is comprised of at least one component of an x-ray cathode assembly. Components of an x-ray cathode assembly include, but are not limited to, a cathode shield, a cathode head, a cathode cup, a filament slot, a cathode head with a cathode cup and a filament slot formed in the cathode head, and a cathode arm extending from the cathode assembly. The deposition process can also be used to coat a complete cathode assembly including the cathode arm that is to be attached to a vacuum enclosure.

In this embodiment, the metal deposition process is carried out by providing an electoforming apparatus comprised of an electroforming chamber, an electrolyte, a metal anode, and an electoforming cathode. At least one component of an x-ray cathode assembly is attached to the electroforming cathode and suspended in an electrolyte. A coating of metal is electrodeposited on the at least one component of an x-ray cathode assembly by running an electrical current through the metal anode and the electroforming cathode so as to deposit metal from the metal anode onto the at least one component of x-ray cathode assembly.

Examples of anode metals that can be used to coat components of an x-ray cathode assembly include, but are not limited to Mo, Ta, Re, W, Nb, V, Ir, Rh, Pt, and Pd. In some instances it may be advantageous to coat a component of a cathode assembly with an alloy and/or a graded alloy where the proportion of the alloying metal is reduced or increased across the thickness of the coating. An alloy coating can be applied to a component of a cathode assembly if the anode material is an alloy or is composed of more than one metal. In some instances, it may be advantageous to convert at least a portion of the metal coating to a carbide, a nitride, or an oxide that has a higher melting point than the base metal used to fabricate the cathode head, cathode shield, or cathode arm.

The electrodeposition of high melting point metals is facilitated by the use of a molten salt electrolyte and high operating temperatures. Examples of suitable temperatures for carrying out the electrodeposition of high melting point metals include temperatures greater than about 500° C., more preferably greater than about 800° C., and up to 1000° C. Examples of suitable molten salts that can be used as electrolytes include, but are not limited to, sodium chloride, potassium chloride, sodium fluoride, potassium fluoride, and the like. Using the temperature ranges and salts listed above, electrodeposited coatings can be applied in a coating thickness range from 5 microns/hr to about 80 microns/hr.

The use of electrodeposition or electroforming processes to manufacture components of an x-ray cathode assembly or to coat one or more components of an x-ray cathode assembly has surprising and unexpected results in the performance of the x-ray cathode. Components manufactured or coated using disclosed electrodeposition methods have superior microcrystalline properties compared to components typically made by powder or ingot metallurgy coupled with conventional fabrication processes. The electrodeposited components can have substantially 100% density that results in essentially zero or very low porosity. The high density and low porosity are advantageous for an x-ray cathode assembly because a 100% dense material does not promote arcing in the way that less dense materials do. For example, cathode assembly components manufactured solely by powder metallurgy or similar processes are less than 100% dense. In addition, the high density coating is essentially 100% pure (i.e., there are no metallic, intermetallic, or non-metallic inclusions in the coating), which allows the cathode assembly to be operated under more strenuous and thus higher performance conditions (e.g., higher voltage and/or higher current), owing to the defect-free surface.

Another advantage of the components manufactured using disclosed electroforming processes is a uniform, columnar microcrystalline structure that the process produces. A photograph showing an example of a columnar microcrystalline structure of an electroformed component is shown in FIG. 7. The microcrystalline grains of the electroformed component are very fine and aligned in a columnar growth direction. The columnar microcrystalline structure provides advantages for any component manufactured using the electroforming process due to the high density and high purity.

Another advantage of cathodes manufactured according to disclosed embodiments is the thickness with which the highly ordered crystal lattice can be grown. The columnar microcrystalline structure can readily be grown to a thickness of greater than 0.75 mm, more preferably greater than 1 mm, and most preferably greater than about 1.25 mm. In some instances, electrodeposited layers can be grown up to about 8 to 10 mm thick. A metal layer grown to such a thickness can provide excellent bonding to the substrate by way of co-deposition of the substrate metal and coating metal. A metal layer grown to such a thickness can also provide a rigidity that avoids the situation where the metal layer delaminates, curls up, or spalls as a result of thermal expansion mismatch between the two metals.

Cathode assemblies manufactured using disclosed processes can achieve high power rating during operation in an x-ray tube due to defect-free surfaces. These higher power ratings allow higher performance when used in an x-ray tube.

Moreover, cathode assemblies manufactured using disclosed processes can provide for an additional advantage by blocking x-ray leakage. For example, x-rays produced by impacting a target with an electron beam diffuse into space in all directions. In a typical cathode assembly, some of these x-rays can pass through the cathode assembly and leak from the x-ray tube housing. Coating the cathode head with a “high” Z material such as tungsten significantly reduces x-ray leakage.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1A is a cross-sectional view of an x-ray cathode assembly according to one embodiment of the invention;

FIG. 1B is another cutaway view of the x-ray cathode assembly of FIG. 1A;

FIG. 1C is a top view of the x-ray cathode assembly of FIG. 1A;

FIG. 2 is a cross-sectional view of an x-ray cathode assembly mounted on an eletroforming cathode for coating according to an embodiment of the invention;

FIG. 3 is a schematic drawing of an electroforming apparatus including an electrolyte, anode, and cathode;

FIG. 4 is a cross-sectional view of an x-ray cathode assembly coated according to an embodiment of the invention;

FIG. 5A is a cross-sectional view similar to what is depicted in FIG. 1A of an x-ray cathode assembly coated according to an embodiment of the invention;

FIG. 5B is a top view of the x-ray cathode assembly of FIG. 5A;

FIG. 6 illustrates the use of the x-ray cathode assembly of the invention in an x-ray tube; and

FIG. 7 is a photograph of a cross-section of a metal layer of an x-ray cathode manufactured using an electroforming process according to an embodiment of the present invention.

### DETAILED DESCRIPTION OF EMBODIMENTS OF THE INVENTION

### I. Introduction

Embodiments of the present invention extend to novel x-ray cathode assemblies and methods for manufacturing the same. In particular, disclosed embodiments are directed to x-ray cathode assemblies that are coated with a layer of deposited material and methods for manufacture thereof The coating process can be used to coat essentially all portions of a cathode assembly or a portion of the cathode assembly. The coating process can be used to provide a durable, high melting, and 100% dense coating to the outer surface of an x-ray cathode assembly. In addition, the coating process can be used to apply metals and other material to the outer surface of the x-ray cathode assembly that cannot be readily applied using traditional techniques such as powder metallurgy. The coating process can be used to manufacture x-ray cathode assemblies with a unique design and/or improved material properties.

As used herein the term “x-ray cathode assembly” refers to a collection of structures that include at least one filament component for emitting a stream of electrons used in generation of x-rays, and structures for focusing the stream of electrons.

As used herein, the term “x-ray tube” refers to a sealed housing that includes a cathode assembly, an anode x-ray target for generation of x-rays and a window for the emission of x-rays.

As used herein the term “exposed outer surface” refers to the surface of the cathode assembly that is exposed to the sealed inner portion inside the x-ray tube housing.

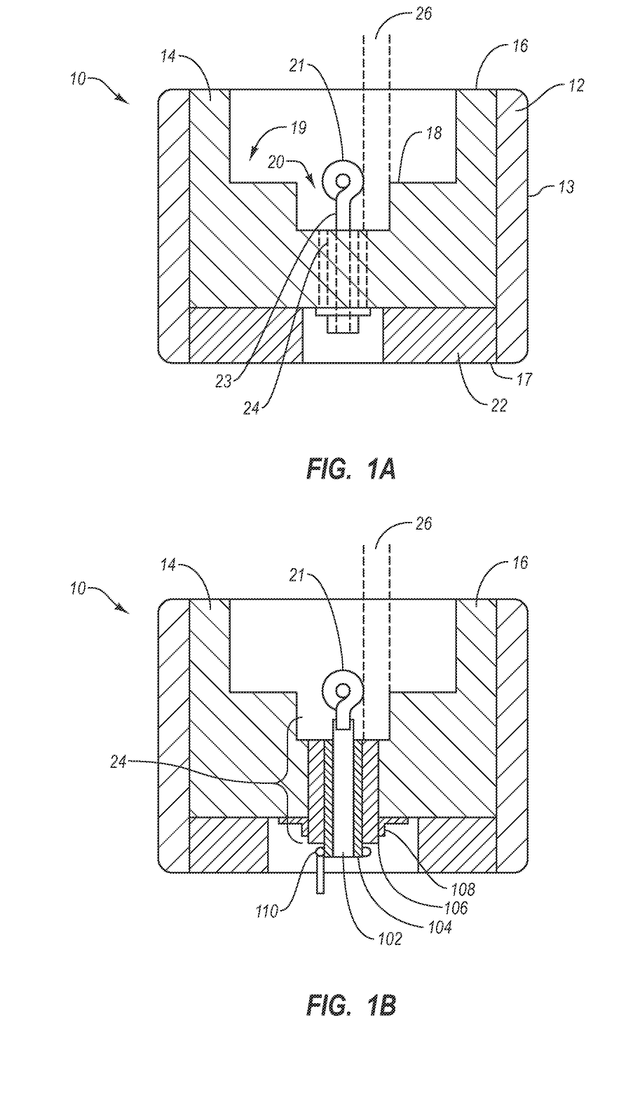

FIGS. 1A, 1B and 1C depict various features of an x-ray cathode assembly. FIG. 1A illustrates a cross-section of a simplified structure of an example x-ray cathode assembly 10. FIG. 1B illustrates a top view of a simplified structure of an example x-ray cathode assembly 10. The cathode assembly 10 generally includes a cathode shield 12, a cathode head 14, a cathode cup 19, a filament slot 20, and a filament 21. The shield 12 and the head 14 can be fabricated separately and then bonded together to form a unitary structure. Bonding can be accomplished by mechanical fastening or spot welding. In some embodiments, the shield 12 and head 14 may be fabricated as a single piece.

The cathode shield 12 and head 14 are generally fabricated from high purity metals using a powder metallurgy process, electron beam melting, vacuum induction melting, vacuum arc melting, and other processes known to those skilled in the art. Example metals used to fabricate the cathode shield 12 and/or cathode head 14 include, but are not limited to nickel, iron, molybdenum, and other nickel, iron, and molybdenum alloys. Powder metallurgy and these other processes typically produce components with a surface that is not 100% dense and/or that often includes non-conductive impurities (i.e., ceramic or intermetallic inclusions). The shield 12 and the head 14 can be fabricated separately and then bonded together to form a unitary structure by way of mechanical fastening with screws or spot welding between the two. In some embodiments, the shield 12 and head 14 may be fabricated as a single piece.

The shield 12 and the head 14 have a top surface 16, a bottom surface 17, and at least one side surface 13. In one embodiment, the cathode cup 19 and a filament slot 20 are formed as a series of stepped depressions protruding into the top surface of the cathode head 14. The filament slot 20 is defined in the cathode cup 19 for housing a filament 21. In another embodiment (not shown), the cathode cup includes a plurality of filament slots and a corresponding plurality of filaments. In some embodiments the cathode assembly 10 is an essentially cubical or rectangular structure as shown; however, in other embodiments the cathode assembly 10 can have other shapes, including a substantially circular structure.

In one embodiment, the filament 21 is preferably composed of a tungsten wire that is wound about a mandrel to form a helical coil. Straight sections of wire 23 extend from the each end portion of the helical filament 21 and pass through a pair of ceramic eyelets 24 inserted through the base of the filament slot 20.

FIG. 1B illustrates a cut-away view of a simplified cathode head assembly 10 showing details of the ceramic eyelets and the electrical connections to the filament 21 and cathode assembly. The ceramic eyelets 24 consist of an alumina sleeve 106 that passes through the head 10 and electrically isolates the head 10 from the filament 21. The inside of the alumina sleeve 106 includes a conductive core made up of a molybdenum or niobium holder 102 and a Kovar piece 104 that is bonded to the alumina sleeve 106. Kovar is a nickel-cobalt ferrous alloy designed to be compatible with the thermal expansion characteristics of the alumina sleeve 106.

The straight sections of wire 23 at each end of the filament 21 are inserted into and bonded to the molybdenum or niobium holder 102. The electrical connection to the filament 21 is made by bonding a pair of electrical leads 110 to each end of the filament via the Kovar piece 104. The electrical leads are connected in turn to a power supply (not shown) that supplies current to the filament. In addition, a second Kovar piece 108 is bonded to the cathode head 10 on the outside of the alumina sleeve 106.

During operation, the filament 21 acts as a source of electrons for x-ray generation. In order to generate x-rays, a heating current is passed through the filament 21 causing electrons to be “boiled” off the filament 21 by thermionic emission. The emitted electrons are accelerated toward an x-ray target by a large electrical potential between the cathode assembly 10 and the target. When the electrons strike the target, some of the electrons interact with the target and produce x-rays. To aid this process, the cathode assembly 10 is designed to focus the electrons emitted by the filament toward the target. As such, the shape of the filament cup 19 and/or the filament slot 20 may be varied as necessary to suit the requirements of a focal spot size for a particular application. For example, the focusing of the electron stream from the filament 21 is enhanced if the transition edge between the bottom face 18 of the cathode cup 19 and the filament slot 20 is configured as a sharp, right, or acute angle.

The following provides a description of x-ray cathode assemblies manufactured using metal deposition processes. As described in more detail below, metal deposition processes can advantageously be used to coat various components of the x-ray cathode assembly, including but not limited to the cathode head with the cathode cup, the cathode shield, the cathode cup, the filament slot, and a cathode head with a cathode cup and a filament slot formed therein. In addition, the deposition processes can be used to coat a cathode assembly that includes a shield, a head, a cathode cup, and a filament slot. X-ray cathode assemblies manufactured, at least in part, using the deposition processes described herein have improved electrical properties compared to cathode assemblies manufactured using other techniques.

### II. Deposition Processes

Cathode assemblies manufactured according to the present invention are coated with a durable, high melting, and substantially 100% dense coating applied to the exposed outer surface of an x-ray cathode assembly. X-ray cathode assemblies manufactured according to the invention have improved material properties and characteristics, such as higher melting point and arc resistance, that provide for longer cathode life in high performance x-ray applications. For example, cathode assemblies coated with a high melting point material, such as tungsten, according to some embodiments of the present invention can be operated at higher temperature, higher current, and higher voltage without experiencing destructive arcing.

Coating processes utilized in the present invention include, but are not limited to, electrodeposition or electroforming, chemical vapor deposition (CVD), physical vapor deposition (PVD), vacuum plasma spray, high velocity oxygen fuel thermal spray, and detonation thermal spraying. These processes of the invention can be used to deposit high melting point metals typically used in manufacturing high performance x-ray cathode assemblies. In addition, these deposited metals can be substantially 100% dense and free of impurities. Examples of high melting point metals that can be used to coat components of an x-ray cathode assembly include, but are not limited to Mo, Ta, Re, W, Nb, V, Ir, Rh, Pt, and Pd.

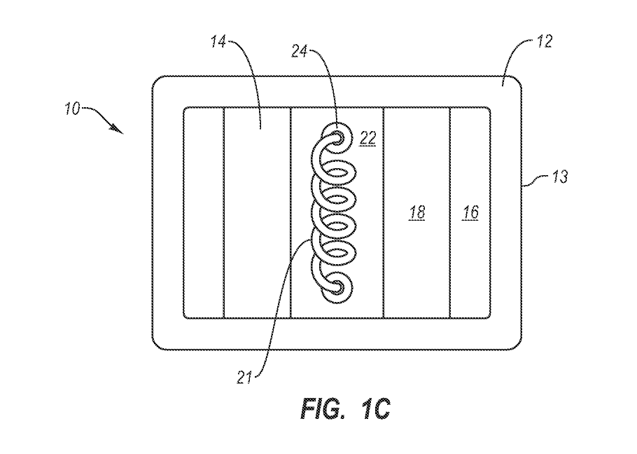

In a preferred embodiment, the deposition process is electroforming. The electroforming process used to manufacture cathode assemblies is carried out by electrodepositing a metal using an electroforming apparatus. FIG. 2 depicts a cross section of an exemplary electroforming cathode 360 used to carry out an electrodeposition process. Electroforming cathode 360 includes an x-ray cathode assembly 30 attached to an electrically conductive post 42. Cathode assembly 30 includes a shield 32, a head 34, a cathode cup 36, a filament slot 38, and an electrically conductive support structure 40 bonded to the back of the cathode assembly 30. The electrically conductive post 42 is mounted to the cathode assembly 30 via the support structure 40. The support structure 40 may be permanently bonded to the cathode assembly, or it may be a sacrificial structure made from a material such as carbon. The electrically conductive post 42, the support structure 40, and the cathode assembly 30 comprise an electroforming cathode 360.

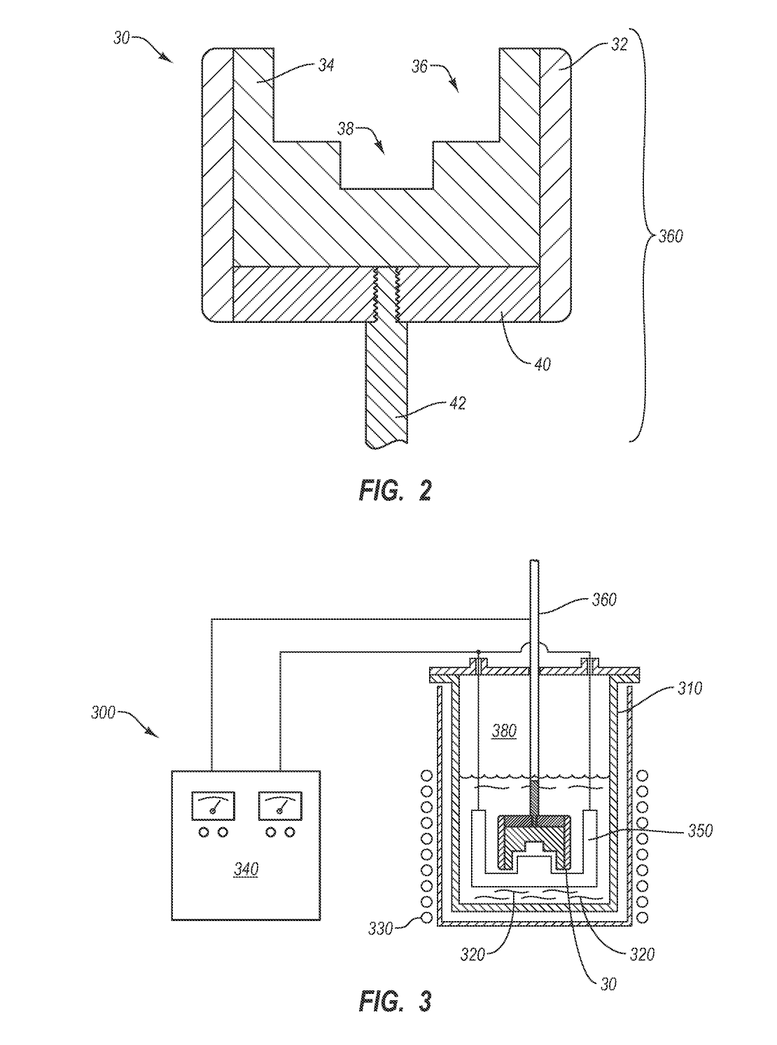

FIG. 3 is a schematic drawing of an electroforming apparatus 300. The electroforming apparatus includes a vessel 310 that holds a liquid electrolyte 320 and an inert atmosphere 380. Vessel 310 can be a graphite material or other material inert to liquid electrolyte 320 at high temperatures. Inert atmosphere 380 can be provided by an inert gas such as nitrogen or argon. A heating element 330 surrounds the vessel 310 and allows the electrolyte to be heated to a desired temperature. Power supply 340 is connected to a positively charged anode 350 and the electroforming cathode 360. The anode 350 includes the metal that is to be consumed during electrodeposition. The metal of anode 350 is submerged in electrolyte 320. The electroforming cathode 360, which includes the cathode assembly 30, is submerged in the electrolyte and spaced apart from the anode 350. As depicted in FIG. 3, the anode 350 may be shaped such that the anode 350 projects into the cathode assembly 30. The electroforming cathode 360 provides the surface where the metal from the anode is deposited.

Applying a voltage across anode 350 and electoforming cathode 360 causes metal to be dissolved in the electrolyte and deposited on the electrically conductive surfaces of the electoforming cathode 360 and the x-ray cathode assembly. Examples of electroforming apparatuses suitable for use with the present invention are devices used with the EL-Form™ process (Plasma Processes, Inc.).

The metals deposited using the electroforming process of the invention can be any metal suitable for use in manufacturing high performance x-ray cathodes. The metals used to manufacture high performance x-ray cathodes are typically high melting-point metals having a melting point above about 1650° C. Examples include Mo, Ta, Re, W, Nb, V, Ir, and Rh. More preferably, the metal is a refractory metal selected from the group of tungsten, molybdenum, niobium, tantalum, and rhenium.

The metals used for electrodeposition can be provided in relatively pure form or alternatively they can be scrap metals having various amounts of contaminants. Impure metals can be used as the anode metal since the electrodeposition process purifies the metal and selectively deposits only pure metal with proper control of electrolyte temperature and power. Thus, the electrodeposition process of the invention can use cheaper, impure sources of metal while achieving very high purity electroformed components.

The electrodeposition is carried out until a desired thickness is reached. The time needed to reach a particular thickness depends on the rate of deposition. In one embodiment the deposition rate is in a range from about 5 micron/hr to about 80 micron/hr, more preferably in a range from about 25 micron/hr to about 50 micron/hr. The thicknesses of the electroformed component are typically limited by the need for a practical duration. The rate of deposition using the electroforming process of the invention can yield thicknesses in a range from about 0.02 mm to about 5 mm, more preferably about 0.75 mm to about 5 mm, even more preferably about 1 mm to about 3.5 mm, and most preferably about 1.25 mm to about 3 mm. In some instances, electrodeposited layers can be grown up to about 8-10 mm thick.

In a preferred embodiment, the electroforming process is carried out at a relatively high temperature. Heating element 330 is used to control the temperature of the electrolyte 320 during deposition of the metal. Examples of suitable temperatures include temperatures greater than about 500° C., more preferably greater than about 800° C., and up to 1000° C. Electroforming performed at these temperatures reduces internal deposition stresses, which allows relatively thick layers of metal to be formed. In addition, deposition at these higher temperatures gives the metals smaller and more uniform grain sizes due to a fast deposition rate. In a preferred embodiment, the microcrystalline structure of the metal deposited at a high temperature is columnar.

The electrolyte used during the deposition process can be any electrolyte capable of acting as an electrically conductive medium to dissolve metal atoms from the anode and transfer the electrically charged metal atoms to the cathode. In one embodiment, the electrolyte is a molten metal salt. Examples of suitable salts include, but are not limited to, chlorides or fluorides of alkaline metals such as Li, Na, K, Rb, Cs, and combinations thereof The salt can be made molten by applying heat using heating element 330 of electroforming apparatus 300.

During the metal deposition, the voltage across the anode and the electroforming cathode allows the metal atoms to be dissolved in the electrolyte and carried through the electrolyte to the cathode. The negative charge on the surface of the cathode causes the positively charged metal atoms in the electrolyte to be deposited. Electrodeposition occurs anywhere there is negatively charged surface in contact with the electrolyte.

The areas where metal is deposited can be controlled either by selecting a component or components of an x-ray cathode for coating or by masking a portion of the surface of the x-ray cathode using a non-conductive material or a conductive, sacrificial material. For example, portions of the x-ray cathode can be masked with a chemically inert and non-conductive material to avoid coating that portion of the x-ray cathode assembly. An example of a suitable non-conductive material is a ceramic material such as boronitride or borocarbide. Where a ceramic material is used, relatively lower temperatures can be used to ensure stability of the ceramic material in the electrolyte. Following electrodeposition, the mask is removed to yield an uncoated surface or surfaces (i.e., uncoated with respect to the material being deposited in that particular deposition step).

In an alternative embodiment, the mask can be a conductive material that is used as a sacrificial mask. In this case the mask can be a graphite or other material that is coated during electrodeposition but the mask can be easily removed so as not to require extensive machining of the x-ray cathode assembly.

The shape of the electroformed component is also determined in part by the thickness of the deposited metal. The thickness is controlled by allowing electrodeposition to continue until the desired thickness of metal is achieved. The thickness of the electroformed component depends on the rate of deposition and the duration of deposition. The rate of deposition can depend on the electrolyte used, the type of metal being deposited, and the voltage applied by the electroforming apparatus. In one embodiment, the rate of deposition used in the method of the invention is in a range from about 5 micron/hr to about 80 micron/hr, more preferably in a range from about 25 micron/hr to about 50 micron/hr.

In one embodiment, the electrodeposition is used to deposit a composite metal or alloy. Using two or more different metals in the electroforming anode results in a uniform deposition of both metals. If desired, the concentration of the two or more metals can be varied throughout the deposition process to yield a layer with a continuously or semi-continuously variable composition (i.e., a graded composition). A graded composition can be used to ensure that certain alloying metals are placed closer to a surface or component interface where the alloying metal is more important for minimizing stress at the interface. Alternatively a graded alloying composition can provide a transition layer between two dissimilar layers, thereby improving the bonding between two dissimilar layers and reducing the likelihood of delamination.

In an alternative embodiment, the deposition process is chemical vapor deposition. CVD is a chemical reaction process that transforms gaseous precursor molecules into a solid material on the surface of a substrate. A variety of metallic films can be grown on surfaces using CVD by starting with a gaseous precursor that contains a desired metal. The gaseous precursor is selectively decomposed at the surface of the substrate leaving a coating of the metal on the surface of the substrate.

By way of example, tungsten metal can be deposited on a surface by starting with tungsten hexafluoride gas. In a typical application the substrate is heated such that the gaseous precursor is decomposed as it flows over the substrate. When the tungsten hexafluoride is decomposed, metallic tungsten is deposited on the substrate leaving gaseous fluorine as a waste product. In an alternative process, the tungsten hexafluoride is mixed with hydrogen gas. In that case, the waste product is hydrogen fluoride gas. Examples of other metals that can be deposited by a CVD process include, but are not limited to, Mo, Ni, Ti, and Ta.

Advantages of CVD include the fact that the process can be used to deposit coatings of a wide variety of metals. In addition, the surface that is being coated does not necessarily have to be conductive and the coatings that are applied are substantially 100% dense. Nevertheless, CVD is limited in the thickness of the coatings that can be grown, growth rates of the coatings range in a few microns per hour, and the waste products are often toxic and/or corrosive.

In another alternative embodiment, the deposition process is physical vapor deposition. The PVD process is highly similar to CVD except that the precursor is a solid material that is ionized or evaporated by bombarding the solid with a high energy source such as a beam of electrons or ions. The ionized or evaporated atoms are then transported to a substrate where they are deposited.

Advantages of PVD are similar to CVD. Disadvantages include the fact that PVD is a so-called line of sight technique, meaning that it is extremely difficult to coat undercuts and other complex surface features. Moreover, PVD is slow, it is expensive, and the thickness of the coatings is limited to a few microns.

In another alternative embodiment, the deposition process is vacuum plasma spray. The vacuum plasma spray process is basically the spraying of molten or heat softened material onto a surface to provide a coating. Material in the form of powder is injected into a high temperature plasma gun, where it is rapidly heated to form liquid droplets and accelerated to a high velocity. The hot liquid droplets impact on the substrate surface and rapidly cools forming a coating. In theory, vacuum plasma spray can be used to apply a coating of essentially any material that can be powdered and that can be made into liquid droplets in the plasma stream. For example, coatings of Mo, Ni, Ta, Re, W, Nb, V, Ir, Rh, Pt, Pd, and oxide, nitride, boride, and carbide derivative thereof can be readily applied with vacuum plasma spray.

Vacuum plasma spray has the advantage that it can spray very high melting point materials such as refractory metals and ceramics unlike the combustion processes described below. Disadvantages of the plasma spray process include the fact that coatings are not essentially 100% dense, the coatings often contain impurities (i.e., if the powderized metal contains impurities or contamination arises in the vacuum chamber, the coating will also contain impurities.).

In another alternative embodiment, the deposition process is high velocity oxygen fuel thermal spray (“HVOF”). In an example HVOF process, fuel and oxygen are fed into a chamber where combustion produces a high pressure flame that is fed down a slender tube increasing its velocity. Powdered material for coating (e.g., metal powder) is fed into the flame stream. The flame stream is directed at the substrate to be coated where the hot material impacts on the substrate surface and rapidly cools forming a coating. In theory, HVOF can be used to apply a coating of essentially any material that can be powdered and that can be made into liquid droplets in the flame stream. For example, coatings of Mo, Ni, Ta, Re, W, Nb, V, Ir, Rh, Pt, Pd, and oxide, boride, nitride, and carbide derivatives thereof can be readily applied with HVOF.

Advantages and disadvantages of HVOF are essentially identical to those listed for vacuum plasma spray.

In another alternative embodiment, the deposition process is detonation thermal spray. A detonation thermal spray apparatus essentially consists of a gun that is used to shoot hot powderized coating material onto a substrate. The detonation gun basically consists of a long water cooled barrel with inlet valves for gases and powder. Oxygen and fuel (e.g., acetylene) are fed into the barrel along with a charge of powder. A spark is used to ignite the gas mixture and the resulting detonation heats and accelerates the powder to supersonic velocity down the barrel. After firing, a pulse of nitrogen is used to purge the barrel and the process is repeated. The high kinetic energy of the hot powder particles on impact with the substrate result in a build up of a very dense and strong coating. In theory, detonation thermal spray can be used to apply a coating of essentially any material that can be powdered and that can be made into liquid droplets in the firing process. For example, coatings of Mo, Ni, Ta, Re, W, Nb, V, Ir, Rh, Pt, Pd, and oxide, nitride, boride, and carbide derivative thereof can be readily applied with detonation thermal spray.

Advantages and disadvantages of detonation thermal spray are essentially identical to those listed for vacuum plasma spray.

### III. X-Ray Cathode Assemblies

X-ray cathode assemblies coated and manufactured according to the present invention are essentially similar to x-ray cathode assembles that are uncoated. The difference lies in the coating. The coating or coatings that are applied allow the cathode assemblies to be used in high performance x-ray applications with higher current, higher voltage, and less arcing relative to uncoated cathode assemblies.

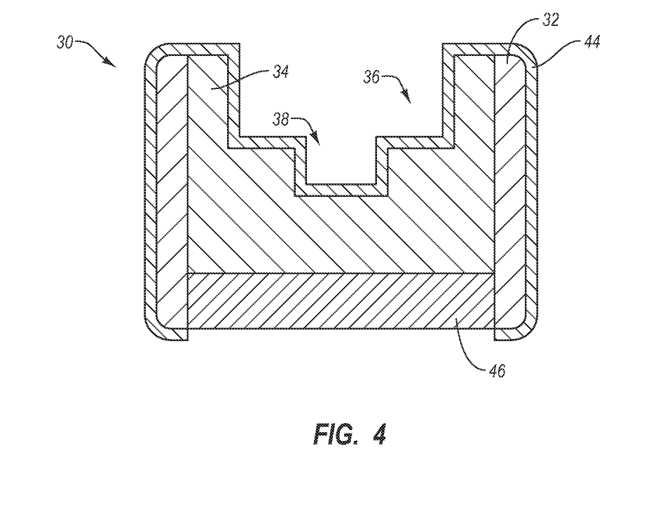

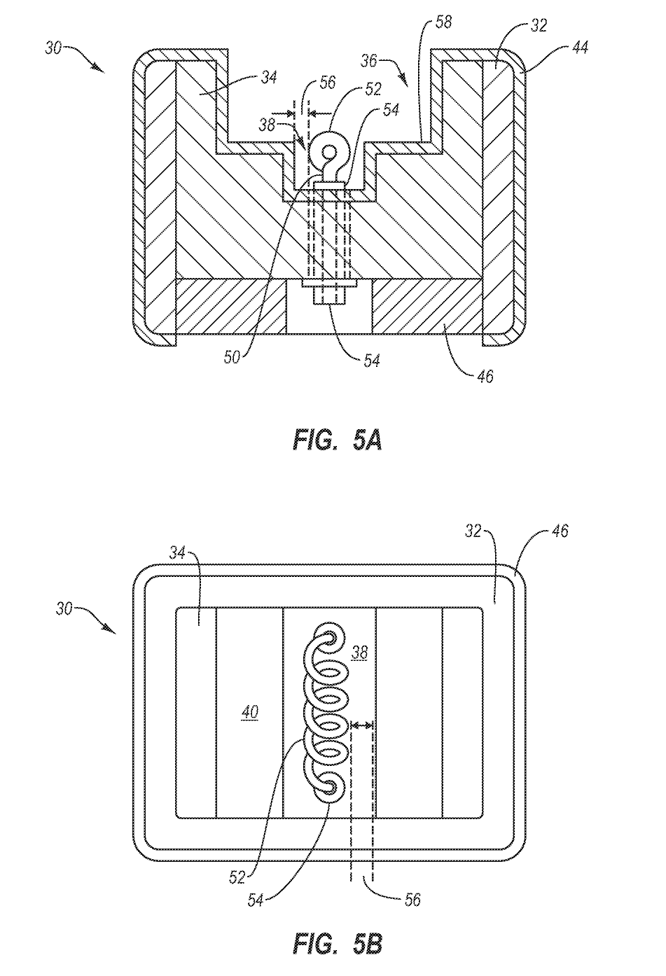

FIGS. 4, 5A, and 5B depict various features of an x-ray cathode assembly coated according to the present invention. FIG. 4 illustrates a cross-section of a simplified structure of an example x-ray cathode assembly 30. FIG. 5A depicts a cross-section of the cathode assembly 30 of FIG. 4 with the addition of a filament 52. FIG. 5B illustrates a top view of the cathode assembly of FIG. 5A. The cathode assembly 30 depicted in FIG. 4 consists of a shield 32, a body 34, a cathode cup 36, a filament slot 38, a coating layer 44, and a shield/head support 46. A finished cathode assembly as depicted in FIGS. 5A and 5B additionally includes a filament 52.

In one embodiment, as depicted in FIG. 4, the coating layer 44 covers essentially the entire exposed outer surface of the cathode assembly 30. In another embodiment (not shown), the coating 44 may only cover a portion of the exposed outer surface of the cathode assembly. For example, the coating 44 may only cover a portion of at least one of the filament slot 38, cathode cup 36, cathode head 34, and/or cathode shield 32.

In some cases, the deposition processes of the invention may deposit material on the cathode assembly 30 somewhat unevenly. For example, deposited material may accumulate on edge surfaces, and the resulting coating may include minor bumps, depressions, or ridges. Moreover, the deposition processes of the invention can alter the dimensions of cathode assembly 30. As such, the cathode assembly 30 is typically machined, ground, and/or polished after coating and before final assembly with ceramic eyelets 54 and filament 52. A coated cathode assembly 30 can be machined using standard mechanical machining techniques and/or electrical discharge machining. A coated cathode assembly 30 can be polished using an electropolishing technique.

Machining and polishing are necessary in part because the performance of the cathode assembly 30 is affected by surface uniformity (or lack thereof). For example, as was explained more fully above, the uniformity of the surface of the cathode assembly 30 tends to affect the probability of arcing between the filament 52 and, for example, the cathode head 34. That is, bumps or depressions on the exposed outer surface of the cathode assembly tend to cause accumulations of charge that lead to arcing. In order to minimize arcing between the cathode head 34 and the filament 52, it can be beneficial if the surface of the cathode assembly 30 is as smooth and uniform as possible. Smoothness and uniformity can be achieved with a combination of machining and electropolishing.

As was more fully explained above, focusing the beam of electrons emitted by the filament is a function of filament placement in the cathode cup 36 and the filament slot 38. For example, the spacing 56 between the filament slot 38 and the filament 52 and the filament coil height above the surface 58 is important for focusing of the electron beam emitted by the filament 52. As was mentioned above, the deposition processes of the invention can alter the dimensions of the cathode assembly 30, and in particular the dimensions of the cathode cup 36 and the filament slot 38. As such, it is beneficial to properly select the dimensions of the cathode cup 36 and the filament slot 38 prior to deposition and to machine the cathode cup 36 and the filament slot 38 after the deposition process in order to achieve the correct spacing 56. The cathode assembly 30 is generally polished after any machining process is completed.

After final surface preparation (i.e., machining and polishing), the cathode assembly is completed by the installation of ceramic eyelets 54 and the installation of the filament 52. The filament 52 is preferably composed of a tungsten wire that is wound about a mandrel to form a helical coil. Straight sections of wire 50 extend from the each end portion of the helical filament 52 and passes through the pair of ceramic eyelets 54 inserted through the base of the filament slot 38. The ceramic eyelets 54 electrically isolate the cathode shield 32 and head 34 from the filament 52. The straight sections of wire 50 at each end of the filament 52 that pass through the ceramic eyelets 54 are each connected to an electrical lead (not shown). The electrical leads are connected in turn to a power supply that supplies current to the filament (not shown).

### IV. Use of X-Ray Cathode in X-Ray Tube and CT-Scanner

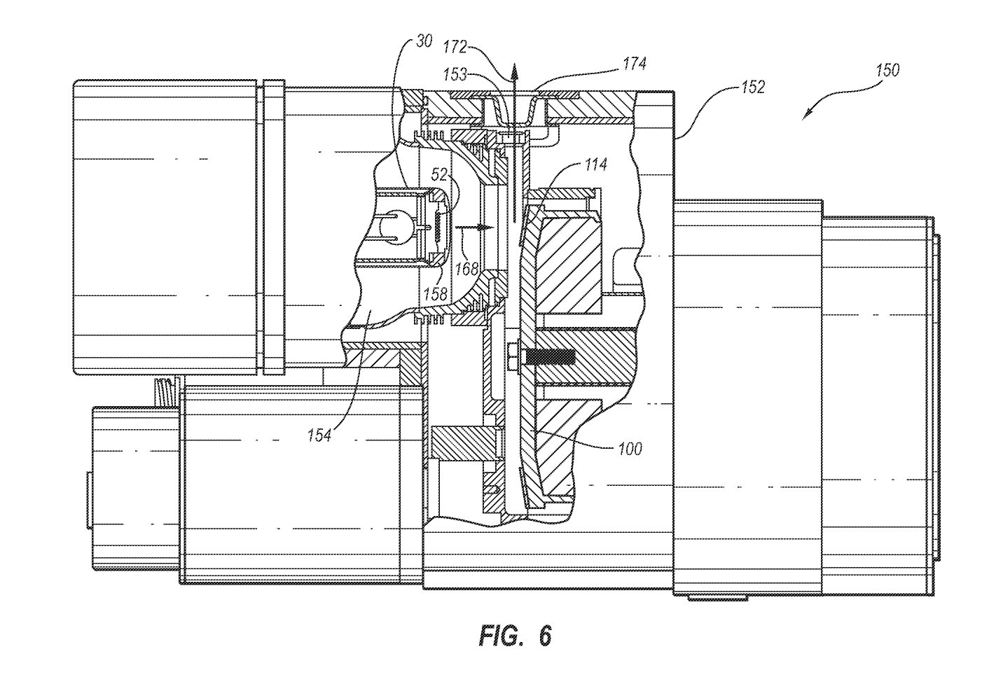

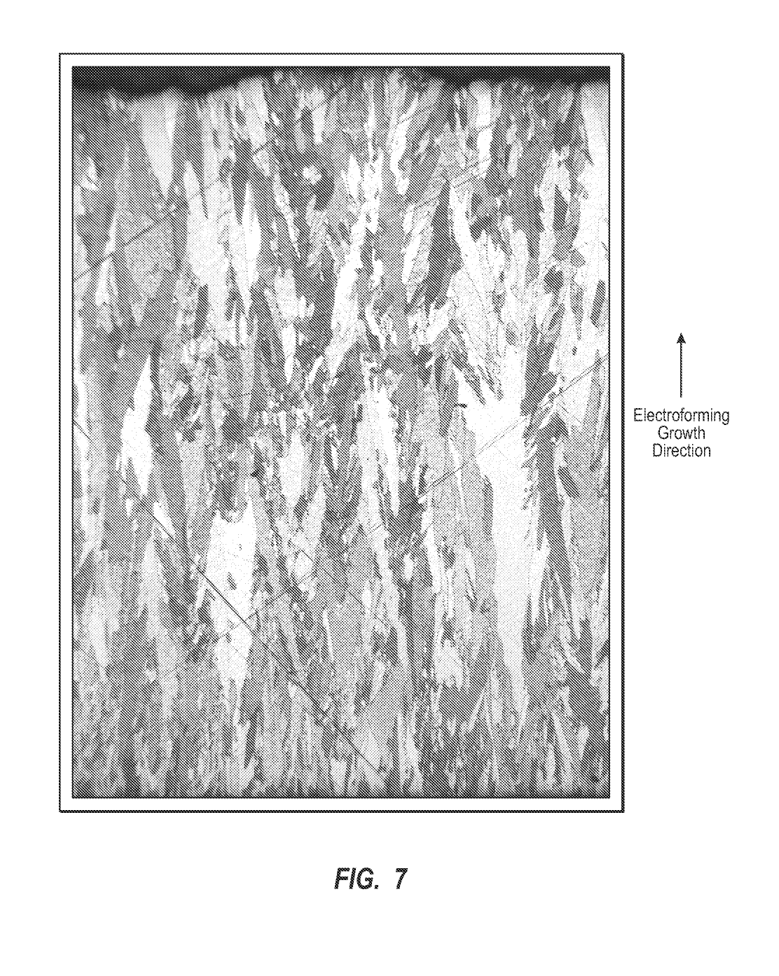

The x-ray cathode assemblies of the present invention can advantageously be incorporated into an x-ray tube. FIG. 6 illustrates an x-ray tube 150 that includes an outer housing 152, within which is disposed in an evacuated enclosure 154. Disposed within evacuated enclosure 154 is a cathode assembly 30 manufactured according to the present invention and a rotating anode x-ray target assembly 100. The cathode assembly 30 is spaced apart from and oppositely disposed to the rotating anode x-ray target assembly 100.

As is typical, a high-voltage potential is provided between the cathode assembly 30 and the anode 100. In the illustrated embodiment, cathode 30 is biased by a power source (not shown) to have a large negative voltage, while assembly 100 is maintained at ground potential. In other embodiments, the cathode 30 is biased with a high negative voltage while the anode 100 is biased with a high positive voltage. Cathode 30 includes at least one filament 52 that is electrically connected to a power source. During operation, electrical current is passed through the filament 52 to cause electrons, designated at 168, to be emitted from cathode 158 by thermionic emission. Application of the high-voltage differential between anode assembly 100 and cathode 158 then causes electrons 168 to accelerate from cathode filament 52 toward a focal track 114 that is positioned on a target surface of rotating assembly 100.

As electrons 168 accelerate, they gain a substantial amount of kinetic energy, and upon striking the target material on focal track 114, some of this kinetic energy is converted into electromagnetic waves of very high frequency (i.e., x-rays). At least some of the emitted x-rays, designated at 172, are directed through an x-ray transmissive window 174 disposed in x-ray tube insert 153. Window 174 is comprised of an x-ray transmissive material such as beryllium so as to enable the x-rays to pass through window 174 and exit x-ray tube 150. The x-rays exiting tube 150 can then be directed for penetration into an object, such as a patient's body during a medical evaluation, or a sample for purposes of metallurgical analysis and/or chemical analysis, and/or baggage inspection.

The high performance capabilities of the x-ray cathode assemblies of the present invention are particularly suitable for use in high performance devices such as computed tomography scanners (“CT-scanners”) or airline baggage scanners. CT-scanners and/or baggage scanners with x-ray tubes incorporating the x-ray cathode assemblies of the invention can achieve higher intensity x-rays that allow user to collect high-contrast images in a shorter period of time. Thus, devices using the x-ray cathode assemblies of the present invention can be made to detect medical or material features that might not otherwise be possible with x-ray cathode assemblies having inferior performance.

The disclosed embodiments are to be considered in all respects only as exemplary and not restrictive. The scope of the invention is, therefore, indicated by the appended claims rather than by the foregoing disclosure. All changes which come within the meaning and range of equivalency of the claims are to be embraced within their scope.

What is claimed is:

1. A method for manufacturing an x-ray cathode assembly using a metal deposition process, comprising:
providing a cathode shield and a cathode head fabricated from a first metal, wherein the cathode shield and the cathode form a unitary structure with a top surface, a bottom surface, and at least one side surface, and wherein a cathode cup and a filament slot are formed into the cathode head;
forming a coating comprising a second metal on at least a portion of at least one of the filament slot, cathode cup, cathode head, and/or cathode shield using a deposition process so as to yield the x-ray cathode assembly; and
providing a filament within the filament slot.

2. A method as in claim 1, wherein the deposition process is chosen from a group consisting of electrodeposition or electroforming, chemical vapor deposition, physical vapor deposition, plasma spray, high velocity oxygen fuel thermal spray, and detonation thermal spraying.

3. A method as in claim 1, wherein the first metal is chosen from a group consisting of molybdenum, nickel, iron, stainless steel, and combinations thereof.

4. A method as in claim 1, wherein the second metal is chosen from a group consisting of Mo, Ni, Ta, Re, W, Nb, V, Ir, Rh, Pt, Pd, and combinations thereof.

5. A method as in claim 4, wherein at least a portion of the second metal is converted to a carbide, a nitride, a boride, an oxide, and combinations thereof.

6. An x-ray cathode assembly manufactured according to the method of claim 1, thereby yielding an x-ray cathode assembly with a metal layer formed thereon that is essentially free of impurities, having a substantially columnar microcrystalline structure, and substantially 100% density.

7. An x-ray cathode assembly as in claim 6, wherein the metal layer has a thickness in a range from about 0.1 mm to about 5 mm.

8. A method for manufacturing an x-ray cathode assembly using a metal deposition process, comprising:
providing at least one component of an x-ray cathode assembly;
providing an electoforming apparatus comprised of an electroforming chamber, an electrolyte, a metal anode, and an electoforming cathode;
attaching the at least one component of an x-ray cathode assembly to the electoforming cathode;
suspending the at least one component and the electroforming cathode in the electrolyte; and
electrodepositing a coating of metal on the at least one component of an x-ray cathode assembly by running an electrical current through the metal anode and the electroforming cathode so as to deposit metal from the metal anode onto the at least one component of x-ray cathode head.

9. A method as recited in claim 8, the at least one component of an x-ray cathode assembly is chosen from a group consisting of a cathode shield, a cathode head with a cathode cup and a filament slot formed in the cathode head, a cathode assembly, and/or a cathode arm.

10. A method as in claim 8, wherein the metal anode is chosen from a group consisting of Mo, Ni, Ta, Re, W, Nb, V, Ir, Rh, Pt, Pd, and combinations thereof.

11. A method as in claim 8, wherein the electrodepositing deposits a metallic coating comprising a graded alloy.

12. A method as in claim 8, wherein the electrolyte is a molten salt.

13. A method as in claim 8, wherein the electrodepositing is carried out at a temperature greater than about 500° C.

14. A method as in claim 8, wherein the rate of electrodepositing is in a range from 5 microns/hour to about 80 microns/hour.

15. A method as in claim 9, wherein at least a portion of the metallic coating on the x-ray cathode substrate is converted to a carbide, a nitride, a boride, an oxide, and combinations thereof.

16. An x-ray cathode assembly manufactured according to the method of claim 8, thereby yielding at least one component of an x-ray cathode assembly with a metal layer applied thereon that is essentially free of impurities, having a substantially columnar microcrystalline structure, and substantially 100% density.

17. An x-ray cathode assembly manufactured according to claim 16, wherein the metal layer has a thickness in a range from about 0.1 mm to about 5 mm.

18. An x-ray cathode assembly with a deposited metallic layer, comprising:
an x-ray cathode assembly comprising a first metal, the cathode assembly having a shield, a head, a cathode cup, a filament slot, and a filament, wherein the shield and the head form a unitary structure with a top surface, a bottom surface, and at least one side surface, and wherein the filament is installed in the head near the bottom of the filament slot;
a coating comprising a second metal, wherein the coating covers at least a portion of the cathode cup and/or filament slot thereby providing an exposed outer surface of the cathode cup and/or filament slot.

19. An x-ray cathode assembly as in claim 18, wherein the coating comprises a substantially columnar crystalline and substantially 100% dense metallic layer that is essentially free of impurities.

20. An x-ray cathode head as in claim 18, wherein the first metal is chosen from a group consisting of molybdenum, nickel, stainless steel, and combinations thereof.

21. An x-ray cathode head as in claim 18, wherein the second metal is chosen from a group consisting of Mo, Ni, Ta, Re, W, Nb, V, Ir, Rh, Pt, Pd, and combinations thereof.

22. An x-ray cathode head as in claim 18, wherein the second metal is deposited on the cathode head with a process chosen from a group consisting of electrodeposition, chemical vapor deposition, physical vapor deposition, plasma spray, high velocity oxygen fuel thermal spray, and detonation thermal spraying.

23. An x-ray cathode head as in claim 18, wherein at least a portion of the metallic layer on the x-ray cathode head is converted to a carbide, a nitride, a boride, or an oxide derivative of the second metal.

24. An x-ray cathode head as in claim 18, wherein the metal layer has a thickness in a range from about 0.002 mm to about 5 mm.

25. An x-ray cathode head as in claim 18, wherein the metal layer has a thickness in a range from about 1 mm to about 3 mm.
